(19) United States
(12) Patent Application Publication
(10) Pub. No.: US 2019/0317893 A1
(43) Pub. Date: Oct. 17, 2019

(54) ADDRESSABLE CONTROL SPACE FOR INTEGRATED CIRCUIT HARDWARE BLOCKS

(71) Applicant: Hewlett Packard Enterprise Development LP, Houston, TX (US)

(72) Inventors: Michael Kontz, Fort Collins, CO (US); Kaitlyn Walker, Houston, TX (US); Jacob Burnham, Fort Collins, CO (US)

(21) Appl. No.: 15/952,861

(22) Filed: Apr. 13, 2018

(51) Int. Cl. G06F 12/06; G06F 12/10

(52) U.S. Cl. CPC G06F 12/06; G06F 12/10

(57) ABSTRACT

An integrated circuit (IC) exposes hardware blocks thereof via an addressable control space defining fields at corresponding global addresses. The addressable control space is shared across the hardware blocks. Each hardware block has implemented fields; the implemented fields of a hardware block are mapped to a subset of the fields of the addressable control space. One or more implemented fields of more than one hardware block are each mapped to the same field of the addressable control space. A hardware block internally compresses the fields of the addressable control space in accordance with its implemented fields to perform a write operation. A hardware block internally expands the implemented fields to the fields of the addressable control space to perform a read operation.

### BACKGROUND

Electronic devices like computing devices can include integrated circuits (ICs) to perform functionality in hardware as opposed to in software. The ICs can be application-specific ICs (ASICs), for instance, or field-programmable gate arrays (FPGAs). To aid in the design of such ICs, preexisting hardware blocks may be employed, either as-is or as a starting point that can then be customized. Such hardware blocks are also referred to as semiconductor intellectual property (IP) cores or IP blocks, and are reusable units of logic, cell, or IC layout design that can be used when designing an IC. A hardware block for IC design can thus be considered analogous to a library for computer programming or to a discrete IC for printed circuit board design.

### BRIEF DESCRIPTION OF THE DRAWINGS

FIG. 1 is a diagram of an example electronic device including an integrated circuit (IC) having hardware blocks.

FIG. 2 is a diagram of an example IC having hardware blocks.

FIG. 3 is a diagram of example performance of a write operation to an IC having hardware blocks.

FIG. 4 is a diagram of example performance of a read operation from an IC having hardware blocks.

FIG. 5 is a flowchart of an example method for performing a write operation to an IC having hardware blocks.

FIG. 6 is a flowchart of an example method for performing a read operation from an IC having hardware blocks.

### DETAILED DESCRIPTION

As noted in the background section, an integrated circuit (IC) can include a number of hardware blocks. In the context of an electronic device that includes the IC, software running on the electronic device, such as via a general purpose processor executing program code stored on a non-transitory computer-readable data storage medium, can interact with the IC, for configuration and status purposes. More specifically, such software can interact with the IC to configure and learn the status of individual hardware blocks that make up the IC.

Each hardware block has a number of internal data fields in this respect, which can be externally exposed outside of the IC to software running on the electronic device of which the IC is a part, and by which the hardware block can be configured or provide status information. Conventionally, each hardware block's data fields are exposed as a separate set of addresses outside of the IC, such that the addressable control space of the IC is effectively a concatenation of the individual data fields of the hardware blocks on a block-by-block basis. However, as the number of hardware blocks and/or the number of internal data fields increases, the available number of global addresses of the IC as a whole becomes a limiting factor. There may not be sufficient addresses to assign to the data fields of every hardware block.

Furthermore, the addressable control space of an IC may be stored in one physical location on the IC's die, and the individual data fields thereof connected by routing wires to their respective hardware blocks. However, with increasing IC die size, resulting in more hardware blocks being added to an IC, such routing from a physical location corresponding to the addressable control space to every hardware block as appropriate becomes unfeasible. Therefore, instead the addressable control space may be mirrored to every hardware block, such that there is no central physical location at which the control space is stored. However, this mirroring approach also does not scale well as the number of hardware blocks and/or the number of internal data fields thereof increases.

Techniques described herein ameliorate these shortcomings. An IC has a common addressable control space defining fields at corresponding global addresses. The addressable control space is shared among hardware blocks of the IC. Each hardware block has a number of implemented fields. The implemented fields of a hardware block are mapped to a subset of the fields of the addressable control space of the IC. One or more of the implemented fields of more than one hardware block are each mapped to the same field within the addressable control space. As such, usage of the available addresses of the IC is conserved, by sharing common fields of hardware blocks within the same field and at the same global address of the addressable control space of the IC. The control structures of the hardware blocks (i.e., their internal data fields) are not just concatenated to form the addressable control space.

Furthermore, when software running on a processor of the IC performs a write operation to the IC, a hardware block can internally compress the fields of the addressable control space according to its implemented fields to effectuate the write operation. That is, the entirety of the addressable control space is not relevant to each hardware block; rather, just the fields of the control space that a hardware block has implemented are. Therefore, each hardware block strips out or removes those fields that it does not implement when performing a write operation. To perform a read operation, a hardware block internally expands its implemented fields, by adding placeholder zeros, for instance, for the fields of the addressable control space that the block does not implement. Such heterogeneous field compression means that that the entire addressable control structure does not have to be mirrored to every hardware block.

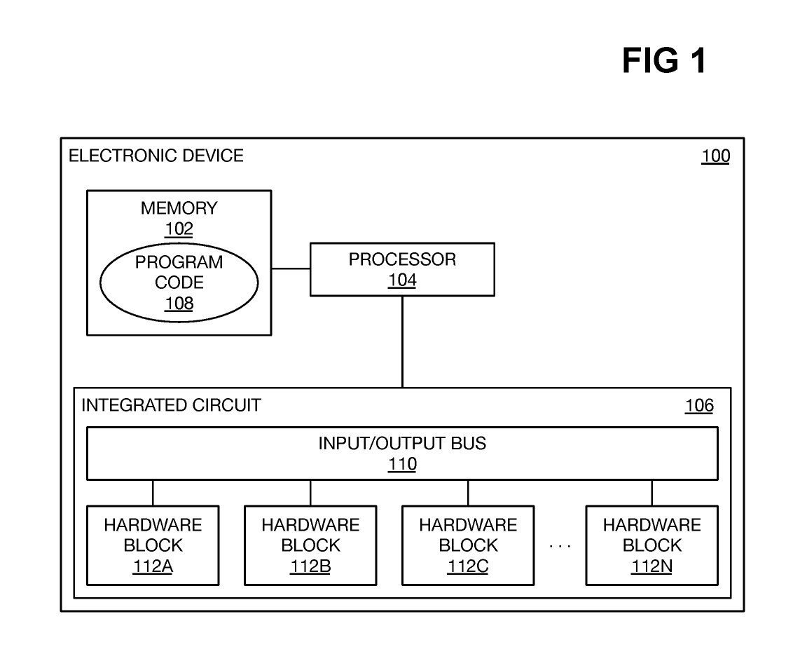

FIG. 1 shows an example electronic device 100. The electronic device 100 can be a computing device, for instance. The electronic device 100 can include a memory 102, a processor 104, and an IC 106. The memory 102 stores program code 108 that the processor 104 executes. As such, the processor 104 can be said to execute software (i.e., the program code 108) to communicate with the IC 106. Just one IC 106 is depicted in FIG. 1 for illustrative clarity and convenience, but there can be more than one IC 106.

The IC 106 includes an input/output (I/O) bus 110 and hardware blocks 112A, 112B, 112C, . . . 112N, which are collectively referred to as the hardware blocks 112. External communication with the hardware blocks 112 of the IC 106, such as by the processor 104 executing the program code 108 of the memory 102, is achieved through the I/O bus 110. The processor 104 can transmit read and write requests to the hardware blocks 112 over the I/O bus 110, and receive responses to these requests from the blocks 112 over the bus 110. That is, I/O bus 110 thus permits the receipt of externally issued read and write requests from outside the IC 106, and the providing of responses to these requests to.

As noted above, the hardware blocks 112 are semiconductor intellectual property (IP) cores or IP blocks, and are reusable units of logic, cell, or IC layout design that can be used when designing the IC 106. In the example of FIG. 1, there are four hardware blocks 112 explicitly shown. However, there can be more or fewer hardware blocks 112. In the context of the techniques described herein, there may be as few as two hardware blocks 112.

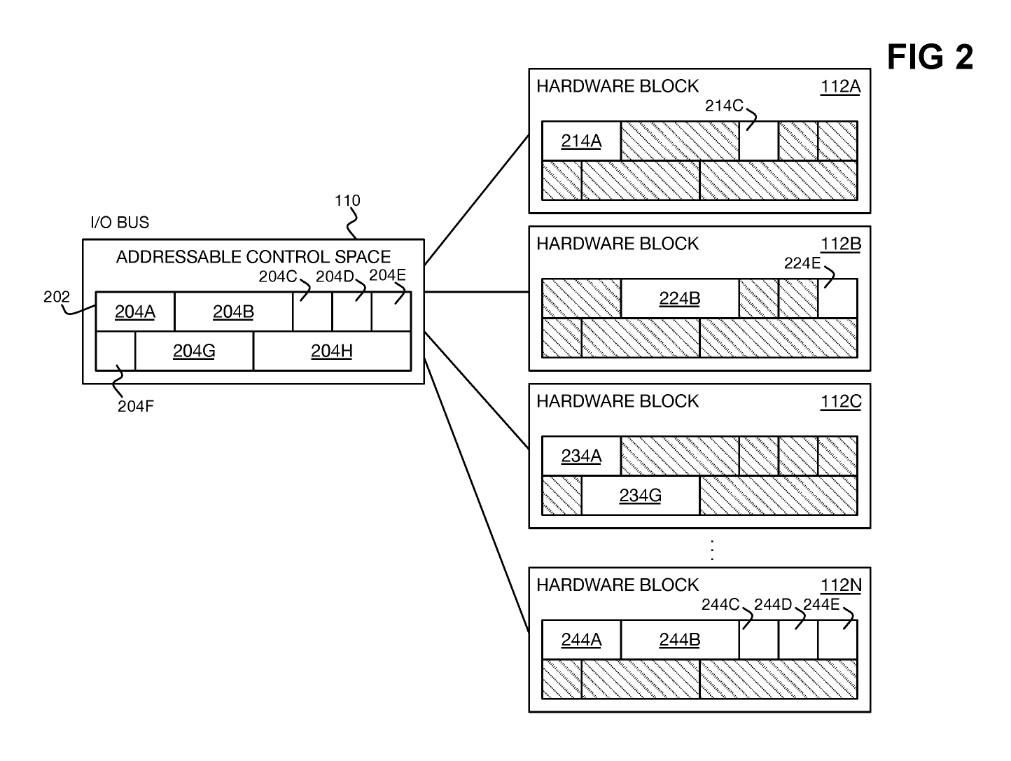

FIG. 2 shows an example IC 106, including the I/O bus 110 and the hardware blocks 112, in detail. The I/O bus 110, and thus the IC 106, has an addressable control space 202. The addressable control space 202 has constituent fields 204A, 204B, 204C, 204D, 204E, 204F, 204G, and 204H, which are collectively referred to as the fields 204. While there are eight fields 204 in the example of FIG. 2, there can be more or fewer fields 204.

The addressable control space 202 is not an actual physical “thing”—such as physical registers, etc.—but rather is depicted in FIG. 2 as a logical construct that is utilized within the IC 106 over the I/O bus 110 for external communication with the hardware blocks 112. That is, the hardware blocks 112 are logically exposed outside the IC 106 via the shared addressable control space 202. Stated another way, the hardware blocks 112 as a group commonly expose the addressable control space 202 so that communication with the blocks 112 can be achieved over the I/O bus 110.

The fields 204 are addressable at corresponding global addresses. As a rudimentary example, the addressable control space 202 may be sixteen bytes in size, with the field 204A at the global address 0×00 corresponding to the beginning of the control space 202. The fields 204B, 204C, 204D, and 204E may have global addresses 0×02, 0×05, 0×06, and 0×07, respectively. The fields 204F, 204G, and 204H may have respective global fields 0×08, 0×09, 0×0B.

Each hardware block 112 is said to internally implement one or more of the fields 204. That a given hardware block 112 internally implements a given field 204 means that the hardware block 112 uses the field 204 for configuration and/or status purposes from outside the block 112 (e.g., by the processor 104 of FIG. 1 through the I/O bus 110). Furthermore, a given hardware block 112 internally implementing the given field 204 means that the hardware block 112 has a physical space, such as a register, at which the block 112 stores the field. The hardware block 112 may internally store an internally implemented such field 204 at a local physical address particular to that block 112, and different than the global address of the field 204 within the addressable control space 202, which is an architectural or logical address.

In the example of FIG. 2, the entire addressable control space 202 is pictorially depicted to underscore which of the fields 204 of the control space 202 are implemented by each hardware block 112. The hardware block 112A has implemented fields 214A and 214C, collectively referred to as the implemented fields 214, and which correspond to or are mapped to the fields 204A and 204C of the addressable control space 202. The hardware block 112A does not implement the other fields 204 of the control space. They are depicted in shaded and unnumbered form in the hardware block 112A in FIG. 2 to illustratively indicate that the hardware block 112A does not use these other fields.

The hardware block 112B has implemented fields 224B and 224E, collectively referred to as the implemented fields 224, and which correspond to or are mapped to the fields 204B and 204E of the addressable control space 202. The hardware block 112C has implemented fields 234A and 234G, collectively referred to as the implemented fields 234, and which correspond to or are mapped to the fields 204A and 204G of the addressable control space. The hardware block 112N has implemented fields 244A, 244B, 244C, 244D, and 244E, collectively referred to as the implemented fields 244, and which correspond to or are mapped to the fields 204A, 204B, 204C, 204D, and 204E of the addressable control space 202.

In the example of FIG. 2, then, the field 204A of the addressable control space 202 is implemented in three hardware blocks 112A, 112C, and 112N, as the implemented fields 214A, 234A, and 244A, respectively. The field 204B of the control space 202 is implemented in the hardware blocks 112B and 112N as the implemented fields 224B and 244E, respectively. The field 204C is implemented in the hardware blocks 112A and 112N as the implemented fields 214C and 244C. The field 204D is implemented in just the hardware block 112N as the implemented field 244D, whereas the field 204E is implemented in the hardware blocks 112B and 112N as the implemented fields 224E and 244E, respectively. The field 204F is not implemented by any hardware block 112, while the field 204G is implemented by just one hardware block 112C as the implemented field 234G. The field 204H is also not implemented by any hardware block 112.

Each field 204 of the addressable control space 202 has the same global address to those hardware blocks 112 that implement the field 204 in question (i.e., that have implemented fields mapped to this field 204). For example, as to the field 204A, the hardware blocks 112A, 112C, and 112N externally address this field via the same global address 0×00. There is not a separate global address within the addressable control space 202 of the IC 106 by which communication is achieved with the hardware blocks 112 over the I/O bus 110. That is, there are not separate global addresses for the (implemented) fields 214A, 234A, and 244A of the hardware blocks 112A, 112C, and 112N, which conserves address space usage within the IC 106.

As noted above, the addressable control space 202 is not actually physically stored in a common location within the IC 106 (such as in the I/O bus 110). Rather, the addressable control space 202 is physically stored within the IC 106 insofar as the implemented fields 214, 224, 234, and 244 mapped to the constituent fields 204 of the control space 202 are physically implemented in their respective hardware blocks 112. Therefore, the I/O bus 110 is physically connected to each hardware block 112. As such, when a write request is received on the I/O bus 110, each hardware block 112 is privy to the values of every field 204 of the addressable control space 202 as specified within the write request.

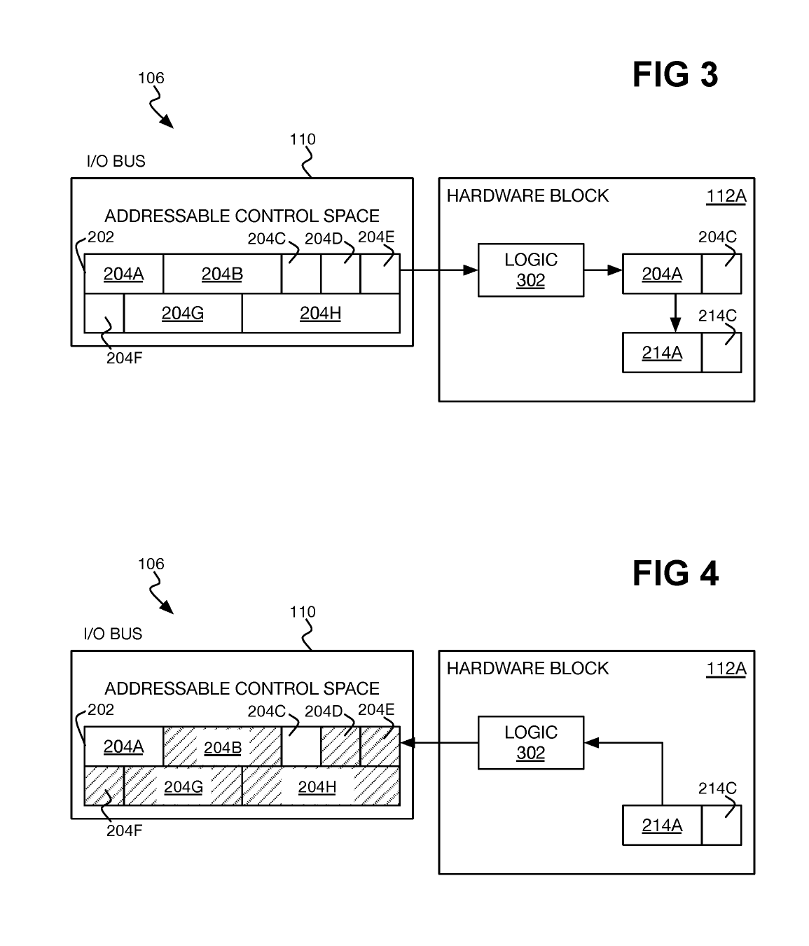

FIG. 3 shows example performance of a write operation within the IC 106. More specifically, FIG. 3 shows example performance of the hardware block 112A performing a write operation. The other hardware blocks 112 are therefore not shown in FIG. 3. Software, such as the program code 108 being executed by the processor 104 from the memory 102 in FIG. 1, writes, via the I/O bus 110, data to the fields 204 at the beginning global logical or architectural address of the addressable control space 202, which can be the address 0×00 of the first field 204A.

The hardware block 112A receives the data written to the addressable control space 202. However, the hardware block 112A implements just two fields 204A and 204C of the addressable control space 202, as the implemented fields 214A and 214C, as has been described. The hardware block 112A includes logic 302 that strips those fields 204 that the block 112A does not implement. The remaining fields 204A and 204C are stored as the implemented fields 214A and 214C, at internal physical addresses of the hardware block 112A that are not exposed outside the block 112A. As such, in performing the write operation, the hardware block 112A effectively compresses the fields 204 of the addressable control space 202 to yield its implemented fields 214.

The logic 302 is implemented in hardware, since the logic 302 is part of the hardware block 112A which itself is part of the IC 106. The logic 302 in this respect may be a hard core or a soft core. A hard core realizes the functionality of the logic 302 via analog, digital, or mixed-signal logic, which is a lower-level logic, including at the transistor level. A soft core realizes the functionality of the logic 302 via a hardware description language, and can be synthesized for implementation via generic gates within the IC 106.

The write operation that has been described in relation to the hardware block 112A is performed for every hardware block 112 with respect to those fields 204 that the hardware block 112 in question implements. For example, the hardware block 112C has logic that strips out the fields 204 of the addressable control space 202 other than the fields 204A and 204G that the block 112C implements as the fields 234A and 234G. That the hardware blocks 112A and 112C (as well as the hardware block 112N) implement the same field 204A, for example, does not matter as how each such block 112A, 112C, and 112N performs the write operation. That is, the hardware blocks 112A, 112C, and 112N perform the field-stripping or field-removal functionality independently of one another.

The example of FIG. 3 has been described in relation to a write request specifying data for all the fields 204 of the addressable control space 202. However, a write request may specify data for a subset of the fields 204, including just a single field 204. The hardware blocks 112 that thus effectuate the write operation are those implementing the fields that are the subject of the corresponding write request.

A read request can also be received on the I/O bus 110. In comparison to a write operation, that more than one hardware block 112 implement the same field 204 of the addressable control space 202 matters with read operations. For example, if a read request is received for the field 204A, there are three hardware blocks 112A, 112B, and 112N that implement this field 204A. Therefore, for each field 204 that has multiple implementing hardware blocks 112, a primary hardware block 112 may be preselected as responsible for responding to read requests of the field 204 in question.

FIG. 4 shows example performance of a read operation within the IC 106. More specifically, FIG. 4 shows example performance of the hardware block 112A performing a read operation. The other hardware blocks 112 are therefore not shown in FIG. 4. Software, such as the program code 108 being executed by the processor 104 from the memory 102 in FIG. 1, submits a read request to read, via the I/O bus 110, data of the fields 204, at the global address of the addressable control space 202.

In the example of FIG. 4, the hardware block 112A is responsible for responding to read requests for the fields 204A and 204C. Therefore, the logic 302 of the hardware block 112A retrieves the data at the physical addresses of the implemented fields 214A and 214C corresponding to the fields 204A and 204C of the addressable control space 202. However, the logic 302 cannot simply return on the I/O bus 110 the fields 214A and 214C as the fields 204A and 204C, since the addressable control space 202 includes other fields 204.

Therefore, the logic 302 adds logic zeros within the addressable control space 202 for those fields 204 that the hardware block 112A does not implement. In the example of FIG. 4, such logically zeroed fields 204 are the fields 204B, 204D, 204E, 204F, 204G, and 204H, which are indicated in FIG. 4 via shading. The logic 302 is thus said to expand the implemented fields 214A and 214C to realize the entirety of the addressable control space 202, where the fields 214A and 214C are returned as the fields 204A and 204C, and logic zeros are returned for each other field 204. The number of logic zeros that are returned for a given non-implemented field 204 is equal to the length of the field 204 in question. For example, four logic zeros will be returned for a non-implemented field 204 that is four bytes in length.

The read request may request more the data or contents of more than one field, for which different hardware blocks 112A and 1128 are primarily responsible. For example, a read request may specify the field 204B in addition to the field 204A. The hardware block 112A may be responsible for fielding read requests of the field 204A, but the block 112A does not implement the field 204B and therefore cannot be responsible for fielding read requests of the field 204B. The hardware block 1128 may instead be responsible for fielding read requests of the field 204B.

The hardware block 112A in this case returns its implemented field 214A as the field 204A of the addressable control space 202, and returns logic zeros for the field 204B. The hardware block 1126 returns logic zeros for the field 204A, and returns its implemented field 224B as the field 204B. So that the zeroing of the field 204B by the hardware block 112A does not overwrite the implemented field 224B that the hardware block 112B returns as the field 204B, the responses from the hardware blocks 112 into the fields 204 of the addressable control space 202 may be logically OR'ed with one another. As such, the logical ORing of the implemented field 224B with logic zeros results in the implemented field 224B being returned as the field 204B. Similarly, the logical ORing of the implemented field 214A with logic zeros results in the implemented field 214A being returned as the field 204A.

FIG. 5 shows an example method 500 for performing a write operation to the IC 106, consistent with the example of FIG. 3. The IC 106 receives a write request at the I/O bus 110 (502). The write request can specify data for one or more of the fields 204 of the addressable control space 202 of the IC 106, at a global address of the control space 202. Each hardware block 112 that implements any field 204 for which data is specified in the write request then performs parts 504 and 506. First, as described above, such a hardware block 112 removes the data of the write request for the fields 204 that the block 112 does not implement, which leaves the data for the fields 204 that the block 112 does implement (504). The hardware block 112 then internally stores the data for these remaining fields at a local physical address of the block 112 (506).

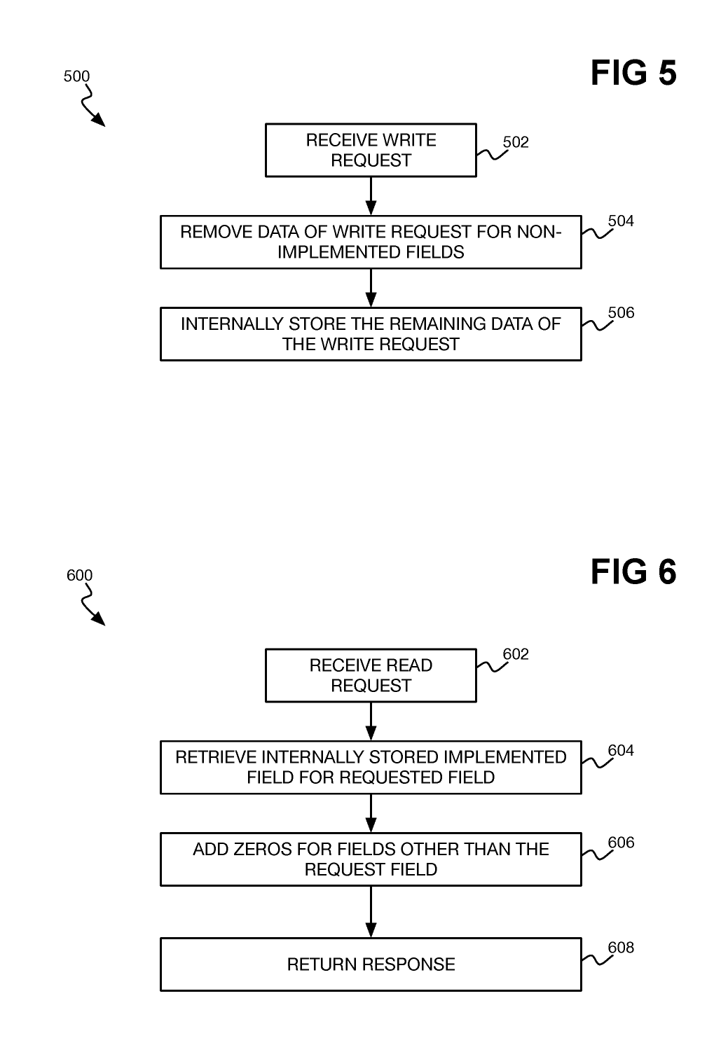

FIG. 6 shows an example method 600 for performing a read operation from the IC 106, consistent with the example of FIG. 4. The IC 106 receives a read request at the I/O bus 110 (602). The read request can solicit data of one or more of the fields 204 of the addressable control space 202 of the IC 106, via specification of a global address of the control space 202. Each hardware block 112 that has previously been selected as responsible for fielding read requests for any field 204 for which data is being requested then performs parts 604, 606, and 608. First, as described above, such a hardware block 112 retrieves the internally stored field(s) for the requested field(s) 204 for which the block 112 is responsible (604). The hardware block 112 zeroes any other field 204 for which the hardware block 112 is not responsible (606)

The hardware block 112 returns the retrieved implemented fields and zeroed fields 204 as the response to the read request, on the I/O bus 110 (608). The hardware block 112 thus effectively returns the addressable control space 202, by returning the fields 204 (either as the implemented fields or the logically zeroed fields) in the order in which they are specified within the control space 202. If more than one hardware block 112 is responding to the read request, the responses of the multiple blocks 112 can be logically OR'ed together, as noted above.

The techniques that have been described herein thus ensure that software can configure the hardware blocks of an IC (i.e., perform write operations) and retrieve the status of the blocks (i.e., perform read operations), even when there are a large number of hardware blocks and/or the hardware blocks have a large number of fields. First, the techniques provide a common addressable space defining fields at corresponding addresses, which the hardware blocks share. Second, the techniques provide for heterogeneous field compression when the hardware blocks perform writes and for heterogeneous field expansion when the blocks perform reads.

We claim:

1. An integrated circuit (IC), comprising:
an input/output (I/O) bus having an addressable control space defining a plurality of fields at corresponding global addresses; and
a plurality of hardware blocks, each hardware block having a plurality of implemented fields, the implemented fields of each hardware block mapped to a subset of the fields of the addressable control space,
wherein one or more of the implemented fields of more than one hardware block are each mapped to a same one of the fields of the addressable control space,
and wherein the addressable control space is shared across the hardware blocks.

2. The IC of claim 1, wherein each hardware block, to perform a write operation, is to internally compress the fields of the addressable control space to the implemented fields of the hardware block, in accordance with the subset of the fields of the addressable control space to which the implemented fields of the hardware block are mapped.

3. The IC of claim 2, wherein each hardware block is to remove from the addressable control space the fields to which the implemented fields of the hardware block are not mapped, in internally compressing the fields of the addressable control space to the implemented fields of the hardware block.

4. The IC of claim 2, wherein each hardware block is to internally store the fields of the addressable control space to which the implemented fields of the hardware block are mapped, at a local physical address of the hardware block, in internally compressing the fields of the addressable control space to the implemented fields of the hardware block.

5. The IC of claim 2, wherein for each field of the addressable control space, a selected hardware block of the hardware blocks of which one of the implemented fields is mapped to the field of the addressable control space is to perform a read operation of the field.

6. The IC of claim 5, wherein for each field of the addressable control space, the selected hardware block is to internally expand the implemented field thereof to which the field of the addressable control space is mapped to the fields of the addressable control space, by zeroing other of the fields, in performing the read operation.

7. The IC of claim 1, wherein the addressable control space, including the fields thereof, is commonly addressed across the hardware blocks.

8. The IC of claim 1, wherein communication with the hardware blocks is achieved over the I/O bus via the addressable control space, the hardware blocks as a whole commonly exposing the addressable control space.

9. The IC of claim 8, wherein the I/O bus is to receive externally issued read and write requests specifying the global addresses of the addressable control space and is to provide responses to the externally issued read and write requests.

10. The IC of claim 1, wherein each hardware block is a semiconductor intellectual property (IP) core.

11. A method comprising:
receiving, by an integrated circuit (IC) at an input/output (I/O) bus thereof, a write request specifying data for a plurality of fields of an addressable control space for a plurality of hardware blocks of IC, at corresponding global addresses of the addressable control space;
removing, by each hardware block, the specified data of the write request for the fields that the hardware block does not implement, leaving the specified data for the fields that the hardware block implements; and
internally storing, by each hardware block, the specified data of the write request for the fields that the hardware block implements, at a local physical address of the hardware block, after removal of the specified data for the fields that the hardware block does not implement,
wherein one or more of the fields of the write request are implemented by more than one of the hardware blocks.

12. The method of claim 11, further comprising:
receiving, by the IC at the I/O bus thereof, a read request for data of a given field of the addressable control space, at one of the global addresses;
retrieving, by a selected hardware block of the hardware blocks that implement the given field, the data for the given field as internally stored by the selected hardware block at the local physical address of the selected hardware block;
adding, by the selected hardware block, zeros for the fields other than the given field; and
returning, by the IC, a response to the read request as the retrieved data for the given field and the zeros for the fields other than the given field, in an order of the fields within the addressable control space.

13. The method of claim 12, wherein retrieval of the data for the given field and addition of the zeros for the fields other than the given field expands the given field that the selected hardware block implements to the fields of the addressable control space.

14. The method of claim 11, wherein removal of the specified data of the write request for the fields that the hardware block does not implement, and leaving of the specified data for the fields that the hardware block implements, compresses the fields of the addressable control space to the field that the hardware block implements.

15. A system comprising:
an integrated circuit having a plurality of hardware blocks and exposing the hardware blocks via an addressable control space defining a plurality of fields at corresponding global addresses; and
a processor to execute software to communicate with the hardware blocks using the addressable control space at the global addresses,
wherein the addressable control space is shared across the hardware blocks.

16. The system of claim 15, wherein each hardware block has a plurality of implemented fields mapped to a subset of the fields of the addressable control space,
wherein one or more of the implemented fields of more than one hardware block are each mapped to a same one of the fields of the addressable control space.

17. The system of claim 16, wherein each hardware block is to internally store the implemented fields at a local physical address of the hardware block.

18. The system of claim 16, wherein each hardware block is to compress the addressable control space by removing the fields of the addressable control space that the hardware block does not implement.

19. The system of claim 16, wherein each hardware block is to expand the fields of the addressable control space that the hardware block does implement to the addressable control space by adding zeros for the fields of the addressable control space that the hardware block does not implement.
